(19) United States
(12) Patent Application Publication
(10) Pub. No.: US 2006/0235107 A1
(43) Pub. Date: Oct. 19, 2006

(54) Method of reusing flexible mold and microstructure precursor composition

(75) Inventors: Yorinobu Takamatsu, Sagamihara-city (JP); Yusuke Saito, Yamato-city (JP); Akira Yoda, Machida-city (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/107,608

(22) Filed: Apr. 15, 2005

(51) Int. Cl. C03C 17/00

(52) U.S. Cl. 523/160

(57) ABSTRACT

The present invention relates to methods of making a microstructures with a flexible mold, microstructure precursor compositions and articles.

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which barrier ribs can be formed on glass substrates is by direct molding. This has involved laminating a mold onto a substrate with a glass- or ceramic-forming composition disposed therebetween. Suitable compositions are described for example in U.S. Pat. No. 6,352,763. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

Although various glass- and ceramic-forming compositions having inorganic particles dispersed in an organic binder have been described, industry would find advantage in new compositions, methods of use, and articles such as display components.

### SUMMARY OF THE INVENTION

In one embodiment is described a method of making a display panel component comprising providing a mold having a polymeric microstructured surface (e.g. suitable for making barrier ribs), placing a rib precursor material comprising a curable organic binder and an inorganic material between the microstructured surface of the mold and an (e.g. electrode patterned) substrate, curing the precursor material, and removing the mold, wherein the method is repeated using the same polymeric mold.

In one aspect the polymeric mold is transparent and has a haze of less than 10% being reused any number of times ranging from at least twice to as many as 30 times or more. The mold is preferably flexible. The microstructured surface of the mold may comprise a cured polymeric material such as the reaction product of at least one (meth)acrylate oligomer and at least one (meth)acrylate monomer. The microstructured surface of the mold is typically disposed on a polymeric support film. The rib precursor material may comprise photoinitiator and may be photocured through the patterned substrate, though the mold, or a combination thereof. In preferred embodiments, the curable organic binder and diluent each have a solubility parameter and the solubility parameter of the diluent is less than the solubility parameter of the curable organic binder such as by a difference of greater than 2 [MJ/m³]^{1/2}.

In another aspect, a curable composition is described comprising: at least one inorganic particulate material, at least one curable organic binder having a solubility parameter, at least one organic diluent having a solubility parameter less than the solubility parameter of the curable organic binder, and optionally photoinitiator, stabilizer, and mixtures thereof. The curable organic binder may comprise at least two (meth)acrylate groups such as (meth)acrylated epoxy, (meth)acrylate urethane, (meth)acrylated polyether, (meth)acrylated polyester, (meth)acrylated polyolefin, (meth)acrylated (meth)acrylic, and mixtures thereof. In particular, the curable organic binder may comprise bisphenol A diglycidyl ether (meth)acrylate, ethylene glycol diglycidyl ether (meth)acrylate, glycerin diglycidyl ether (meth)acrylate, and mixtures thereof. The organic diluent may comprise for example alkylene glycol monoalkyl ether, dialkylene glycol monoalkyl ether, polyalkylene glycol monoalkyl ether, alkylene glycol monoalkyl ether acetate, dialkyl succinate, dialkyl adipate, dialkyl glutarate, and mixtures thereof.

In other embodiments, the invention relates to articles such as a display component and intermediates thereof. The intermediate comprises a substrate and a plurality of barrier ribs comprised of any of the (e.g. rib) precursor or cured compositions described herein disposed on a substrate. During sintering of the precursor, the binder and diluent are volatilized and thus may not be detectable in the end product.

### BRIEF DESCRIPTION OF THE DRAWINGS

FIG. 1 is a perspective view of an illustrative flexible mold suitable for making barrier ribs.

FIG. 2A-2C is a section view, in sequence of an illustrative method of making a fine structure (e.g. barrier ribs) by use of a flexible mold.

### DETAILED DESCRIPTION OF THE PREFERRED EMBODIMENTS

The present invention relates to curable compositions suitable for making barrier ribs, methods of making microstructures (e.g. barrier ribs), as well as (e.g. display) components and articles having microstructures. Hereinafter, the embodiments of the invention will be explained with reference to method of making barrier rib microstructures with a (e.g. flexible) polymeric mold. The curable compositions can be utilized with other (e.g. microstructured) devices and articles such as for example, electrophoresis plates with capillary channels and lighting applications. In particular, devices and articles that can utilize molded glass- or ceramic-microstructures can be formed using the methods described herein. While the present invention is not so limited, an appreciation of various aspects of the invention will be gained through a discussion of methods, apparatus and articles for the manufacture of barrier ribs for PDPs.

The recitation of numerical ranges by endpoints includes all numbers subsumed within the range (e.g. the range 1 to 10 includes 1, 1.5, 3.33, and 10).

Unless otherwise indicated, all numbers expressing quantities of ingredients, measurements of properties, and so like as used in the specification and claims are to be understood to be modified in all instances by the term “about.”

(“Meth)acryl” refers to functional groups including acrylates, methacrylates, acrylamide, and methacrylamide.

“(Meth)acrylate” refers to both acrylate and methacrylate compounds.

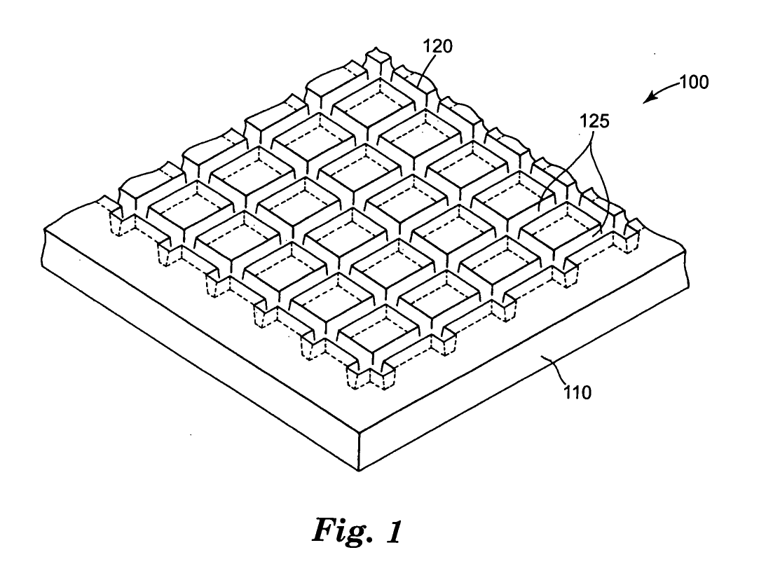

FIG. 1 is a partial perspective view showing an illustrative flexible mold 100. The flexible mold 100 generally has a two-layered structure having a planar support layer 110 and a microstructured surface, referred to herein as a shape-imparting layer 120 provided on the support. The flexible mold 100 of FIG. 1 is suitable for producing a grid-like rib pattern of barrier ribs on a (e.g. electrode patterned) back panel of a plasma display panel. Another common barrier ribs pattern (not shown) comprises plurality of (non-intersecting) ribs arranged in parallel with each other.

Although the support 110 may optionally comprise the same material as the shape-imparting layer for example by coating the polymerizable composition onto the transfer mold in an amount in excess of the amount needed to only fill the recesses, the support is typically a preformed polymeric film. The thickness of the polymeric support film is typically at least 0.025 millimeters, and typically at least 0.075 millimeters. Further the thickness of the polymeric support film is generally less than 0.5 millimeters and typically less than 0.175 millimeters. The tensile strength of the polymeric support film is generally at least about 5 kg/mm² and typically at least about 10 kg/mm². The polymeric support film typically has a glass transition temperature (Tg) of about 60° C. to about 200° C. Various materials can be used for the support of the flexible mold including cellulose acetate butyrate, cellulose acetate propionate, polyether sulfone, polymethyl methacrylate, polyurethane, polyester, and polyvinyl chloride. The surface of the support may be treated to promote adhesion to the polymerizable resin composition. Examples of suitable polyethylene terephthalate based materials include photograde polyethylene terephthalate and polyethylene terephthalate (PET) having a surface that is formed according to the method described in U.S. Pat. No. 4,340,276; incorporated herein by reference.

The depth, pitch and width of the microstructures of the shape-imparting layer can vary depending on the desired finished article. The depth of the microstructured (e.g. groove) pattern 125 (corresponding to the barrier rib height) is generally at least 100 μm and typically at least 150 μm. Further, the depth is typically no greater than 500 μm and typically less than 300 μm. The pitch of the microstructured (e.g. groove) pattern may be different in the longitudinal direction in comparison to the transverse direction. The pitch is generally at least 100 μm and typically at least 200 μm. The pitch is typically no greater than 600 μm and typically less than 400 μm. The width of the microstructured (e.g. groove) pattern 4 may be different between the upper surface and the lower surface, particularly when the barrier ribs thus formed are tapered. The width is generally at least 10 μm, and typically at least 50 μm. Further, the width is generally no greater than 100 μm and typically less than 80 μm.

The thickness of an illustrative shape-imparting layer is generally at least 5 μm, typically at least 10 μm, and more typically at least 50 μm. Further, the thickness of the shape-imparting layer is generally no greater than 1,000 μm, typically less than 800 μm and more typically less than 700 μm. When the thickness of the shape-imparting layer is below 5 μm, the desired rib height for many PDP panels cannot be obtained. When the thickness of the shape-imparting layer is greater than 1,000 μm, warp and reduction of dimensional accuracy of the mold can result due to excessive shrinkage.

The flexible mold is typically prepared from a transfer mold, having a corresponding inverse microstructured surface pattern as the flexible mold. The transfer mold may have a microstructured surface comprised of a cured (e.g. silicone rubber) polymeric material, such as described in U.S. application Ser. No. 11/030261 filed Jan. 6, 2005 (Docket No. 59452US002), incorporated herein by reference.

Flexible mold 100, can be used to produce barrier ribs on a substrate for a (e.g. plasma) display panel. Prior to use, the flexible mold or components thereof may be conditioned in a humidity and temperature controlled chamber (e.g. 22° C./55% relative humidity) to minimize the occurrence of dimensional changes during use. Such conditioning of the flexible mold is described in further detail in WO2004/010452; WO2004/043664 and JP Application No. 2004-108999, filed Apr. 1, 2004; incorporated herein by reference thereof

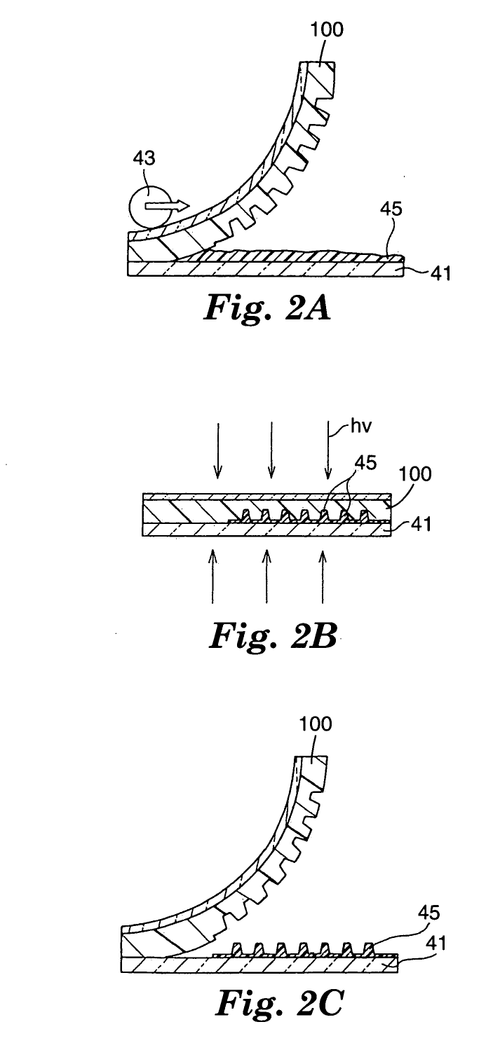

With reference to FIG. 2A, a flat transparent (e.g. glass) substrate 41, having an (e.g. striped) electrode pattern is provided. The flexible mold 100 of the invention is positioned for example by use of a sensor such as a charge coupled device camera, such that the barrier pattern of the mold is aligned with the patterned substrate. A barrier rib precursor 45 such as a curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. As depicted in FIG. 2A, a (e.g. rubber) roller 43 may be employed to engage the flexible mold 100 with the barrier rib precursor. The rib precursor 45 spreads between the glass substrate 41 and the shape-imparting surface of the mold 100 filling the groove portions of the mold. In other words, the rib precursor 45 sequentially replaces air of the groove portions. Subsequently, the rib precursor is cured. The rib precursor is preferably cured by radiation exposure to (e.g. UV) light rays through the transparent substrate 41 and/or through the mold 100 as depicted on FIG. 2B. As shown in FIG. 2C, the flexible mold 100 is removed while the resulting cured ribs 48 remain bonded to the substrate 41.

The flexible mold has a polymeric microstructured surface that is susceptible to damage by exposure to the curable rib precursor. Although the flexible mold may comprise other (e.g. cured) polymeric materials, at least the microstructured surface of the flexible mold typically comprises the reaction product of a polymerizable composition generally comprises at least one ethylenically unsaturated oligomer and at least one ethylenically unsaturated diluent. The ethylenically unsaturated diluent is copolymerizable with the ethylenically unsaturated oligomer. The oligomer generally has a weight average molecular weight (Mw) as determined by Gel Permeation Chromatography (described in greater detail in the example) of at least 1,000 g/mole and typically less than 50,000 g/mole. The ethylenically unsaturated diluent generally has a Mw of less than 1,000 g/mole and more typically less than 800 g/mole.

The polymerizable composition of the flexible mold is preferably radiation curable. “Radiation curable” refers to functionality directly or indirectly pendant from a monomer, oligomer, or polymer backbone (as the case may be) that react (e.g. crosslink) upon exposure to a suitable source of curing energy. Representative examples of radiation crosslinkable groups include epoxy groups, (meth)acrylate groups, olefinic carbon-carbon double bonds, allyloxy groups, alpha-methyl styrene groups, (meth)acrylamide groups, cyanate ester groups, vinyl ethers groups, combinations of these, and the like. Free radically polymerizable groups are preferred. Of these, (meth)acryl functionality is typical and (meth)acrylate functionality more typical. Typically at least one of the ingredients of the polymerizable composition, and most typically the oligomer, comprises at least two (meth)acryl groups.

Various known oligomers having (meth)acryl functional groups can be employed. Suitable radiation curable oligomers include (meth)acrylated urethanes (i.e., urethane (meth)acrylates), (meth)acrylated epoxies (i.e., epoxy (meth)acrylates), (meth)acrylated polyesters (i.e., polyester (meth)acrylates), (meth)acrylated (meth)acrylics, (meth)acrylated polyethers (i.e., polyether (meth)acrylates) and (meth)acrylated polyolefins. The oligomer(s) and monomer(s) preferably have a glass transition temperature (Tg) of about −80° C. to about 60° C., respectively, meaning that the homopolymers thereof have such glass transition temperatures.

The oligomer is generally combined with the monomeric diluent(s) in amounts of 5 wt-% to 90 wt-% of the total polymerizable composition of the flexible mold. Typically, the amount of oligomer is at least 20 wt-%, more typically at least 30 wt-%, and more typically at least 40 wt-%. In at least some preferred embodiments, the amount of oligomer is at least 50 wt-%, 60 wt-%, 70 wt-%, or 80 wt-%.

Various (meth)acryl monomers are known including for example aromatic (meth)acrylates including phenoxyethylacrylate, phenoxyethyl polyethylene glycol acrylate, nonylphenoxy polyethylene glycol, 3-hydroxyl-3-phenoxypropyl acrylate and (meth)acrylates of ethylene oxide modified bisphenol; hydroxyalkyl (meth)acrylates such as 4-hydroxybutylacrylate; alkylene glycol (meth)acrylates and alkoxy alkylene glycol (meth)acrylates such as methoxy polyethylene glycol monoacrylate and polypropylene glycol diacrylate; polycaprolactone (meth)acrylates; alkyl carbitol (meth)acrylates such as ethylcarbitol acrylate and 2-ethylhexylcarbitol acrylate; as well as various multifunctional (meth)acryl monomers including 2-butyl-2-ethyl-1,3-propanediol diacrylate and trimethylolpropane tri(meth)acrylate.

In some embodiments, the polymerizable composition of the flexible mold may comprise one or more urethane (meth)acrylate oligomers such as commercially available from Daicel-UCB Co., Ltd. under the trade designation “EB 270” and “EB 8402”. In other embodiments, the polymerizable composition of the flexible mold may comprise one or more polyolefin (meth)acrylate oligomers such as commercially available from Osaka Organic Chemical Industry Ltd., under the trade designation “SPDBA”. Other suitable flexible mold compositions are known. Preferred flexible mold compositions are described in concurrently filed Attorney Docket No. 60456; incorporated herein by reference.

The curable rib precursor (also referred to as “slurry” or “paste”) comprises at least three components. The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening. The rib precursor preferably has a viscosity of less than 20,000 cps and more preferably less than 5,000 cps to uniformly fill all the microstructured groove portions of the flexible mold without entrapping air.

Various curable organic binders can be employed. The curable organic binder is curable for example by exposure to radiation or heat. Alternatively, the binder can be a thermoplastic material that is heated to a liquid state to conform to the mold and then cooled to a hardened state to form microstructures adhered to the substrate. It is typically preferred that the binder is radiation curable under isothermal conditions (i.e. no change in temperature). This reduces the risk of shifting or expansion due to differential thermal expansion characteristics of the mold and the substrate, so that precise placement and alignment of the mold can be maintained as the rib precursor is hardened. Accordingly, the rib precursor is preferably photocurable.

In general the curable organic binder of the rib precursor composition may comprise any of the photocurable oligomers and monomers previously described for use in the polymerizable composition of the flexible mold. Typically, however, photocurable monomers are preferred over oligomers to insure the rib precursor composition has a suitable viscosity after being combined with the inorganic particulate material.

The diluent is not simply a solvent compound for the resin. The diluent is preferably soluble enough to be incorporated into the resin mixture in the uncured state. Upon curing of the binder of the slurry, the diluent should phase separate from the monomers and/or oligomers participating in the cross-linking process. Preferably, the diluent phase separates to form discrete pockets of liquid material in a continuous matrix of cured resin, with the cured resin binding the particles of the glass frit or ceramic powder of the slurry. In this way, the physical integrity of the cured green state microstructures is not greatly compromised even when appreciably high levels of diluent are used (i.e., greater than about a 1:3 diluent to resin ratio). This provides two advantages. First, by remaining a liquid when the binder is hardened, the diluent reduces the risk of the cured binder material adhering to the mold. Second, by remaining a liquid when the binder is hardened, the diluent phase separates from the binder material, thereby forming an interpenetrating network of small pockets, or droplets, of diluent dispersed throughout the cured binder matrix.

Photocurable rib precursor compositions further comprise one or more photoinitiators at a concentrations ranging from 0.01 wt-% to 1.0 wt-% of the polymerizable resin composition. Suitable photointitiators include for example, 2-hydroxy-2-methyl-1-phenylpropane-1-one; 1-[4-(2-hydroxyethoxy)-phenyl]-2-hydroxy-2-methyl-1-propane-1-one; 2,2-dimethoxy-1,2-diphenylethane-1-one; 2-methyl-1-[4-(methylthio)phenyl]-2-morpholino-1-propanone; and mixtures thereof.

The rib precursor may optionally comprise various additives including but not limited to surfactants, catalysts, etc. as known in the art. For example, the rib precursor may comprise 0.1 to 1 parts by weight of a phosphorus-based compound alone or in combination with 0.1 to 1 parts by weight of a sulfonates based compounds. Such compounds are described in PCT Patent Application US04/26701; incorporated herein by reference. Further, the rib precursor may comprise an adhesion promoter such as a silane coupling agent to promote adhesion to the substrate (e.g. glass panel of PDP).

In amount of curable organic binder in the rib precursor composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

The Applicant has found that the flexible mold can be reused. The number of times the flexible mold can be reused relates to the rib precursor composition employed in the method for making the microstructures. By proper selection of the rib precursor composition as described herein, the flexible mold can be reused any number of times ranging from at least one reuse to at least 5 reuses. In preferred embodiments the polymeric transfer mold can be reused at least 10 times, at least 20 times, or at least 30 times. The transfer mold can be reused when the extent of swelling of the microstructured surface of the flexible mold is less than 10% and more typically less than 5%, as can be determined by visual inspection with a microscope.

For embodiments wherein the rib precursor is cured through the flexible mold, the flexible mold is suitable for reuse when the flexible mold is sufficiently transparent. A sufficiently transparent flexible mold typically has a haze (as measured according to the test method described in the examples) of less than 15%, preferably of less than 10% and more preferably no greater than 5% after a single use. Even more preferably, the flexible mold has the haze criteria just described after being reused at least 5 times.

In preferred embodiments, the rib precursor comprises a diluent having a solubility parameter that is less than the curable organic binder.

The solubility parameter of various monomers, δ (delta), can conveniently be calculated using the expression:
δ=(ΔEv/V)^{1/2},
where ΔEv is the energy of vaporization at a given temperature and V is the corresponding molar volume. According to Fedors' method, the SP can be calculated with the chemical structure (R. F. Fedors, Polym. Eng. Sci., 14(2), p.147, 1974, Polymer Handbook 4^{th} Edition “Solubility Parameter Values” edited by J. Brandrup, E. H. Immergut and E. A. Grulke).

The difference between the solubility parameter of the curable binder and the diluent is at least 1 [MJ/m³]^{1/2} and typically at least 2 [MJ/m³]^{1/2}. The difference between the solubility parameter of the curable binder and the diluent is preferably at least 3 [MJ/m³]^{1/2}, 4 [MJ/m³]^{1/2}, or 5 [MJ/m³]^{1/2}. The difference between the solubility parameter of the curable binder and the diluent is more preferably at least 6 [MJ/m³]^{1/2}, 7 [MJ/m³]^{1/2}, or 8 [MJ/m³]^{1/2}. The difference between the solubility parameter of the curable binder and the diluent is typically no greater than 30 [MJ/m³]^{1/2}.

Various organic diluents can be employed depending on the choice of curable organic binder. In general suitable diluents include various alcohols and glycols such as alkylene glycol (e.g. ethylene glycol, propylene glycol, tripropylene glycol), alkyl diol (e.g. 1, 3 butanediol,), and alkoxy alcohol (e.g. 2-hexyloxyethanol, 2-(2-hexyloxy)ethanol, 2-ethylhexyloxyethanol); ethers such as dialkylene glycol alkyl ethers (e.g. diethylene glycol monoethyl ether, dipropylene glycol monopropyl ether, tripropylene glycol monomethyl ether); esters such as lactates and acetates and in particular dialkyl glycol alkyl ether acetates (e.g. diethylene glycol monoethyl ether acetate); alkyl succinate (e.g. diethyl succinate), alkyl glutarate (e.g. diethyle glutarate), and alkyl adipate (e.g. diethyl adipate).

The glass- or ceramic-forming particulate material (e.g. powder) is chosen based on the end application of the microstructures and the properties of the substrate to which the microstructures will be adhered. One consideration is the coefficient of thermal expansion (CTE) of the substrate material (e.g. glass panel of PDP). Preferably, the CTE of the glass- or ceramic-forming material of the slurry of the present invention differs from the CTE of the substrate material (e.g. electrode patterned glass panel of a PDP) by no more than 10%. When the substrate material has a CTE which is much less than or much greater than the CTE of the ceramic material of the microstructures, the microstructures can warp, crack, fracture, shift position, or completely break off from the substrate during processing. Further, the substrate can warp due to a high difference in CTE between the substrate and the fired microstructures. Inorganic particulate materials suitable for use in the slurry of the present invention preferably have coefficients of thermal expansion of about 5×10⁻⁶/° C. to 13×10⁻⁶/° C.

Glass and/or ceramic materials suitable for use in the slurry of the present invention typically have softening temperatures below about 600° C., and usually above 400° C. The softening temperature of the ceramic powder indicates a temperature that must be attained to fuse or sinter the material of the powder. The substrate generally has a softening temperature that is higher than that of the ceramic material of the rib precursor. Choosing a glass and/or ceramic powder having a low softening temperature allows the use of a substrate also having a relatively low softening temperature.

Lower softening temperature ceramic materials can be obtained by incorporating certain amounts of lead, bismuth, or phosporous into the material. Suitable composition include for example i) ZnO and B₂O₃; ii) BaO and B₂O₃; iii) ZnO, BaO, and B₂O₃; iv) La₂O₃ and B₂O₃; and v) Al₂O₃, ZnO, and P₂O₅. Other low softening temperature ceramic materials are known in the art. Other fully soluble, insoluble, or partially soluble components can be incorporated into the ceramic material of the slurry to attain or modify various properties.

The preferred size of the particulate glass- or ceramic-forming material of the rib precursor depends on the size of the microstructures to be formed and aligned on the patterned substrate. The average size, or diameter, of the particles is typically no larger than about 10% to 15% the size of the smallest characteristic dimension of interest of the microstructures to be formed and aligned. For example, the average particle size for PDP barrier ribs is typically no larger than about 2 or 3 microns.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,352,763; U.S. Pat. No. 6,843,952, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; PCT Application No. US04/33170, filed Oct. 8, 2004; PCT Application No. US04/26701, filed Aug. 17, 2004; PCT Application No. US04/26845, filed Aug. 18, 2004; and PCT Application No. US04/23472 filed Jul. 21, 2004.

The present invention is illustrated by the following non-limiting examples.

TABLE I
Ingredients Employed in the Preparation of the Flexible Mold

| | | Trade | |
|---|---|---|---|
| | Vendor | Designation | |
| Chemical Name | Name | Abbreviation | Function |
| Polyether based urethane | Daicel-UCB | EB 270 | Oligomer |
| acrylate | Co., Ltd | | |
| Polyester based urethane | Daicel-UCB | EB 8402 | Oligomer |
| acrylate | Co., Ltd | | |
| Hydrogenated | Osaka | SPBDA | Oligomer |
| polybutadiene diacrylate | Organic | | |
| | Chemical | | |
| | Ind., Ltd. | | |
| Phenoxyethylacrylate | Osaka | POA | Diluent |
| | Organic | | |
| | Chemical | | |
| | Industry, | | |
| | Ltd. | | |
| ε-caprolactone modified | Daicel | FA2D | Diluent |
| hydroxyalkylacrylate | Chemical | | |
| | Industry | | |
| Lauryl acrylate | Osaka | LA | Diluent |
| | Organic | | |
| | Chemical | | |
| | Industry, | | |
| | Ltd. | | |
| 2-hydroxy-2-methyl-1- | CIBA | Darocur 1173 | Photoinitiator |
| phenylpropane-1-one, | Specialty | | |
| | Chemical | | |
| 1-[4-(2-hydroxyethoxy)- | CIBA | Irgacure 2959 | Photoinitiator |
| phenyl]-2-hydroxy-2- | Specialty | | |
| methyl-1-propane-1-one | Chemical | | |

Preparation of Flexible Mold A

80 parts by weight (pbw) of Ebecryl 270 acrylated urethane oligomer, 20 pbw phenoxyethylacrylate monomer and 1 pbw of Darocur-1173 photoinitiator were mixed at ambient temperature and coated on 188 microns polyester film (PET) support with the thickness of 300 microns. The coated surface was laminated to a 38 micron release PET liner and cured with 1,000 mj/cm² of ultraviolet light through the PET liner with a fluorescent lamp having a peak wavelength at 352 nm (manufactured by Mitsubishi Electric Osram LTD). After removing the release liner, Mold A (having the cured polymerizable resin on the PET support) was obtained. The haze of Mold A was 4.2%.

Preparation of Mold B

Mold B was prepared in the same manner as Mold A except that the polymerizable composition contained 80 pbw of Ebecryl 8402, 20 pbw of FA2D monomer and 1 pbw of Irgacure 2959 photointiator. The haze of Mold-B was 4.0%.

Preparation of Mold C

Mold B was prepared in the same manner as Mold A except that the polymerizable composition contained 90 pbw of SPBDA oligomer, 10 pbw of lauryl acrylate monomer and 1 pbw of Darocur 1173 photoinitiator. The haze of Mold C was 4.7%.

TABLE 2
Ingredients Employed in the Preparation of the Rib Precursor

| | | Trade | |
|---|---|---|---|
| | | Designation | |
| Chemical Name | Vendor Name | Abbreviation | Function |
| Dimethacrylate of | Kyoeisya | Epoxyester | Curable |
| bisphenol A diglycidyl | Chemical | 3000M | binder |
| ether | Co., Ltd. | (“3000M”) | |
| Triethylene glycol | Wako Pure | TEGDMA | Curable |
| dimethacrylate | Chemical | | binder |
| | Industries, | | |
| | Ltd. | | |
| Dimethacrylate of | Kyoeisya | Epoxyester | Curable |
| ethylene glycol diglycidyl | Chemical | 40EM | binder |
| ether | Co., Ltd. | (“40EM”) | |
| Diacrylate of grycerin | Kyoeisya | Epoxyester | Curable |
| diglycidyl ether | Chemical | 40EM | Binder |
| | Co., Ltd. | (“80MFA”) | |
| 1,3-butane-diol | Wako Pure | 1,3-butane- | Diluent |
| | Chemical | diol | |
| | Industries, | | |
| | Ltd. | | |
| Propylene glycol | Wako Pure | Propylene | Diluent |
| | Chemical | glycol | |
| | Industries, | | |
| | Ltd. | | |
| Diethylene Glycol | Tokyo Kasei | DEGEE | Diluent |
| Monoethyl Ether | Kogyo Co., | | |
| | Ltd. | | |
| 2-Hexyloxy-ethanol | Wako Pure | 2-Hexyloxy- | Diluent |
| | Chemical | ethanol | |
| | Industries, | | |
| | Ltd. | | |
| Dipropylene Glycol | Wako Pure | DPGBE | Diluent |
| Monobutyl Ether | Chemical | | |
| | Industries, | | |
| | Ltd. | | |
| Ethylene-glycol | Wako Pure | Ethylene- | Diluent |
| | Chemical | glycol | |
| | Industries, | | |
| | Ltd. | | |
| Diethylene Glycol | Tokyo Kasei | DEGEEAc | Diluent |
| Monoethyl Ether Acetate | Kogyo Co., | | |
| | Ltd. | | |
| Diethyl Succinate | Wako Pure | Diethyl | Diluent |
| | Chemical | Succinate | |
| | Industries, | | |
| | Ltd. | | |
| Dipropylene Glycol | Wako Pure | DPGPE | Diluent |
| Monopropyl Ether | Chemical | | |
| | Industries, | | |
| | Ltd. | | |
| Basic acrylic polymer | Kyoeisya | DOPA-17 | Stabilizer |
| | Chemical | | |
| | Co., Ltd. | | |
| Basic acrylic polymer | Kyoeisya | DOPA-33 | Stabilizer |
| | Chemical | | |
| | Co., Ltd. | | |
| Phosphate ester | 3M Co. | POCAII | Stabilizer |
| sodium dodecylbenzene | Kao | Neopelex No. | Stabilizer |
| sulfonate | Corporation | 25 | |
| Co-polymer containing | Ajinomoto- | PB821 | Stabilizer |
| basic functional groups | Fine-Techno | | |
| | Co., Inc. | | |
| Tri-propylene glycol | Tokyo Kasei | Tri- | Diluent |
| | Kogyo Co., | propylene | |
| | Ltd. | glycol | |
| 2-(2- | Wako Pure | | Diluent |
| hexyoxyethoxy)ethanol | Chemical | | |
| | Industries, | | |
| | Ltd. | | |
| Di-propylene glycol | Wako Pure | | Diluent |
| mono-methyl ether | Chemical | | |
| | Industries, | | |
| | Ltd. | | |
| Diethyl Glutarate | Tokyo Kasei | Diethyl | Diluent |
| | Kogyo Co., | Glutarate | |
| | Ltd. | | |
| Di-propylene glycol | Wako Pure | DPGPE | Diluent |
| mono-propyl ether | Chemical | | |
| | Industries, | | |
| | Ltd. | | |
| Diethyl Adipate | Wako Pure | Diethyl | Diluent |
| | Chemical | Adipate | |
| | Industries, | | |
| | Ltd. | | |
| 2-Ethylhexyoxyethanol | Wako Pure | | Diluent |
| | Chemical | | |
| | Industries, | | |
| | Ltd. | | |
| Tri-propylene glycol | Tokyo Kasei | | Diluent |
| mono-methyl ether | Kogyo Co., | | |
| | Ltd. | | |
| bis(2,4,6-trimethylbenzoyl)- | CIBA | Irgacure | Photo- |
| phenylphosphine-oxide | Specialty | 819 | initiator |
| | Chemical | | |
| 2,4,6-trimethylbenzoyl- | BASF | Lucirin | Photo- |
| diphenylphosphine-oxide | | TPO | initiator |
| Lead borosilicate glass | Asahi Glass | RFW-030 | Glass |
| powder | Co., Ltd. | | frit |

Preparation of Curable Organic Binder of the Rib Precursor

50 pbw of the (meth)acrylate curable binder of column 3 of Table III and 50 pbw of the diluent of column 4 of Table 3 and 0.7 pbw of Irgacure 819 were mixed at ambient temperature. The organic binder composition was applied at a thickness of 250 microns between two 38 micron PET films. The rib precursor was cured by exposure to 0.16 mW/cm² light with a fluorescent lamp (manufactured by Philips) having a peak wavelength at 400-500 nm for 3 minutes. The cured material becomes hazy if phase separation occurs after curing (“Yes”) and remains clear after curing if phase separation does not occur (“No”). The phase separation results are reported in column 7 of Table III.

Preparation of Rib Precursor

100.7 pbw of the uncured curable organic binder set forth in Table 3-5, 100.7 pbw of the diluent set forth in Tables 3-5, 3.5 pbw of POCA II (a phosphate stabilizer, manufactured by 3M), 3.5_pbw of Neopelex™ No. 25 (sodium dodecylbenzene sulfonate, manufactured by Kao Corporation) and 595.9_pbw of glass frit (RFW-030) were mixed with Conditioning Mixer AR-250 (manufactured by THINKY Corporation) at ambient temperature until homogeneous.

Viscosity

The viscosity was measured with a rotation viscometer manufactured by Tokyo Keiki Co., under the trade designation “BM-type” at 22° C. The viscosity of each rib precursor composition reported in Tables 3-5 was in the range of 8.0-15.0 Pa-s.

Reuseability Test of the Flexible Mold

Each of the rib precursor compositions of Table 3 were coated on 2.8 mm glass substrate (PD200 from Asahi Glass Co., Ltd.) at a thickness of 250 microns. The flexible mold was laminated to the coated glass by use of a roller. The rib precursor was cured with 0.16 mW/cm² light by irradiating through the flexible mold for 3 minutes with a fluorescent lamp having a peak wavelength at 400-500 nm (Philips). The mold was then separated leaving the cured barrier ribs bonded to the glass substrate.

For each different rib composition (i.e. each row in Table 3) the procedure was repeated for 5 times using the same flexible mold. The haze of the flexible mold after 1 use and 5 resuses is recorded in columns 8 and 9 of Tables 3-5. Table 3 shows the results with Mold A, Table 4 shows the results with Mold B, Table 5 uses Molds A-C as indicated in the table.

TABLE 3
Phase Separation and Reusability of Mold A

| | Curable | | Diluent | | | | | |
|---|---|---|---|---|---|---|---|---|
| | (Meth)acrylate | | | | Boiling | | Reuseability | |
| | Binder | | | | point of | Phase | (Haze %) | |
| | | SP value | | SP value | Diluent | Sep. | 1 time | 5 times |
| Comp A | 3000M/TEGDMA | 22.7 | Propylene glycol | 27.6 | 187 | Yes | 13.7 | 25.1 |
| | (70/30) | (Cal) | | (Cal) | | | | |
| Comp B | 3000M/TEGDMA | 22.7 | 1,3-Butanediol | 26.1 | 204 | Yes | 10.2 | 24.9 |
| | (70/30) | (Cal) | | (Cal) | | | | |
| Ex. 1 | 3000M/TEGDMA | 22.7 | Tri-propylene glycol | 22.3 | 273 | No | 4.5 | 5.9 |
| | (70/30) | (Cal) | | (Cal) | | | | |
| Ex. 2 | 3000M/TEGDMA | 22.7 | DEGEE (Di-ethylene | 20.7 | 202 | No | 4.7 | 5.8 |
| | (70/30) | (Cal) | glycol mono-ethyl | (Cal) | | | | |
| | | | ether) | | | | | |
| Ex. 3 | 3000M/TEGDMA | 22.7 | 2-Hexyloxyethanol | 19.9 | 208 | Yes | 4.6 | 10.4 |
| | (70/30) | (Cal) | | (Cal) | | | | |
| Ex. 4 | 3000M/TEGDMA | 22.7 | 2-(2-Hexyloxyethoxy) | 19.8 | 260 | Yes | 4.4 | 5.7 |
| | (70/30) | (Cal) | ethanol | (Cal) | | | | |
| Ex. 5 | 3000M/TEGDMA | 22.7 | Di-propylene glycol | 19.8 | 190 | Yes | 4.5 | 5.9 |
| | (70/30) | (Cal) | mono-methyl ether | (Cal) | | | | |
| Ex. 6 | 3000M/TEGDMA | 22.7 | Diethyl Succinate | 19.7 | 218 | Yes | 4.6 | 6.0 |
| | (70/30) | (Cal) | | (Cal) | | | | |
| Ex. 7 | 3000M/TEGDMA | 22.7 | Diethyl Glutarate | 19.5 | 237 | Yes | 4.5 | 5.9 |
| | (70/30) | (Cal) | | (Cal) | | | | |
| Ex. 8 | 3000M/TEGDMA | 22.7 | DPGPE (Di-propylene | 19.4 | 212 | Yes | 4.6 | 6.0 |
| | (70/30) | (Cal) | glycol mono-propyl | (Cal) | | | | |
| | | | ether) | | | | | |
| Ex. 9 | 3000M/TEGDMA | 22.7 | Diethyl Adipate | 19.4 | 251 | Yes | 4.7 | 6.1 |
| | (70/30) | (Cal) | | (Cal) | | | | |
| Ex. 10 | 3000M/TEGDMA | 22.7 | DPGBE (Di-propylene | 19.3 | 227 | Yes | 4.6 | 5.8 |
| | (70/30) | (Cal) | glycol mono-butyl | (Cal) | | | | |
| | | | ether) | | | | | |
| Ex. 11 | 3000M/TEGDMA | 22.7 | 2-Ethylhexyloxyethanol | 19.3 | 229 | Yes | 5.0 | 6.5 |
| | (70/30) | (Cal) | | (Cal) | | | | |
| Ex. 12 | 3000M/TEGDMA | 22.7 | Tri-propylene glycol | 19.3 | 243 | Yes | 4.8 | 6.2 |
| | (70/30) | (Cal) | mono-methyl ether | (Cal) | | | | |
| Comp C | 40EM | 25.1 | Ethylene glycol | 30.3 | 197 | No | 15.0 | 25.0 |
| | | (Cal) | | (Cal) | | | | |
| Ex. 13 | 40EM | 25.1 | DEGEE (Di-ethylene | 20.7 | 202 | No | 4.6 | 6.4 |
| | | (Cal) | glycol mono-ethyl | (Cal) | | | | |
| | | | ether) | | | | | |
| Ex. 14 | 40EM | 25.1 | 2-Hexyloxyethanol | 19.9 | 208 | Yes | 4.6 | 6.0 |
| | | (Cal) | | (Cal) | | | | |
| Ex. 15 | 40EM | 25.1 | DPGPE (Di-propylene | 19.4 | 212 | Yes | 4.7 | 6.1 |
| | | (Cal) | glycol mono-propyl | (Cal) | | | | |
| | | | ether) | | | | | |
| Ex. 16 | 40EM | 25.1 | 2-Ethylhexyloxyethanol | 19.3 | 229 | Yes | 5.4 | 7.0 |
| | | (Cal) | | (Cal) | | | | |
| Ex. 17 | 40EM | 25.1 | DPGBE (Di-propylene | 19.3 | 227 | Yes | 5.9 | 5.7 |
| | | (Cal) | glycol mono-butyl | (Cal) | | | | |
| | | | ether) | | | | | |
| Ex. 18 | 40EM | 25.1 | DEGEEAc (Di-ethylene | 18.4 | 218 | Yes | 5.0 | 6.2 |
| | | (Cal) | glycol mono-ethyl | (Cal) | | | | |
| | | | ether acetate) | | | | | |
| Comp D | 80MFA | 28.3 | Ethylene glycol | 30.3 | 197 | Yes | 20.0 | 54.4 |
| | | (Cal) | | (Ref. 2) | | | | |
| Ex. 19 | 80MFA | 28.3 | 1,3-Butanediol | 26.1 | 204 | Yes | 4.6 | 5.6 |
| | | (Cal) | | (Ref. 2) | | | | |
| Ex. 20 | 80MFA | 28.3 | Tri-propylene glycol | 22.3 | 273 | Yes | 5.4 | 7.0 |
| | | (Cal) | | (Cal) | | | | |
| Ex. 21 | 80MFA | 28.3 | DEGEE (Di-ethylene | 20.7 | 202 | No | 4.6 | 6.0 |
| | | (Cal) | glycol mono-ethyl | (Cal) | | | | |
| | | | ether) | | | | | |
| Ex. 22 | 80MFA | 28.3 | 2-Hexyloxyethanol | 19.9 | 208 | Yes | 5.1 | 6.1 |
| | | (Cal) | | (Cal) | | | | |
| Ex. 23 | 80MFA | 28.3 | Diethyl Succinate | 19.7 | 218 | Yes | 5.1 | 5.4 |
| | | (Cal) | | (Cal) | | | | |
| Ex. 24 | 80MFA | 28.3 | DPGPE (Di-propylene | 19.4 | 212 | Yes | 5.0 | 5.8 |
| | | (Cal) | glycol mono-propyl | (Cal) | | | | |
| | | | ether) | | | | | |
| Ex. 25 | 80MFA | 28.3 | 2-Ethylhexyloxyethanol | 19.3 | 229 | Yes | 5.0 | 6.5 |
| | | (Cal) | | (Cal) | | | | |
| Ex. 26 | 80MFA | 28.3 | DPGBE (Di-propylene | 19.3 | 227 | Yes | 5.3 | 6.9 |
| | | (Cal) | glycol mono-butyl | (Cal) | | | | |
| | | | ether) | | | | | |
| Ex. 27 | 80MFA | 28.3 | DEGEEAc (Di-ethylene | 18.4 | 218 | Yes | 5.0 | 5.5 |
| | | (Cal) | glycol mono-ethyl | (Cal) | | | | |
| | | | ether acetate) | | | | | |

Cal [MPa^{1/2}]: Calculated by using Fedors method (R. F. Fedors, Polym. Eng. Sci., 14(2), P. 147, 1974)

TABLE 4
Phase Separation and Reusability of Mold B

| | Curable | | | | Reuseability |
|---|---|---|---|---|---|
| | (Meth)acrylate | | | Phase | (Haze %) |
| | Binder | Diluent | Ratio | Separation | 5 times |
| Ex. 28 | 80MFA | DPGPE | 60:40 | Yes | 5.4 |
| Ex. 29 | 80MFA | DPGPE | 50:50 | Yes | 5.5 |
| Ex. 30 | 80MFA | DPGPE | 40:60 | Yes | 5.3 |

TABLE 5
Phase Separation and Mold Reusability of Mold

| | Curable | | | | | Reuseability |
|---|---|---|---|---|---|---|
| | (Meth)acrylate | | | | | (Haze %) |
| | Binder | Diluent | Initiator | Stabilizer | Mold | 5 times |
| Comp E | 3000M/TEGDMA | 1,3-Butanediol | Irgacure | POCAII/ | Mold-A | 24.9 |
| | (70/30) | | 819 | Neopelex | | |
| | | | | No. 25 | | |
| Comp F | 3000M/TEGDMA | 1,3-Butanediol | Irgacure | POCAII/ | Mold-B | 31.3 |
| | (70/30) | | 819 | Neopelex | | |
| | | | | No. 25 | | |
| Comp G | 3000M/TEGDMA | 1,3-Butanediol | Irgacure | POCAII/ | Mold-C | 53.0 |
| | (70/30) | | 819 | Neopelex | | |
| | | | | No. 25 | | |
| Ex. 31 | 80MFA | DPGPE | Irgacure | POCAII/ | Mold-A | 5.8 |
| | | | 819 | Neopelex | | |
| | | | | No. 25 | | |
| Ex. 32 | 80MFA | DPGPE | Irgacure | POCAII/ | Mold-B | 5.5 |
| | | | 819 | Neopelex | | |
| | | | | No. 25 | | |
| Ex. 33 | 80MFA | DPGPE | Irgacure | POCAII/ | Mold-C | 5.0 |
| | | | 819 | Neopelex | | |
| | | | | No. 25 | | |
| Ex. 34 | 80MFA | DPGPE | Irgacure | DOPA-17 | Mold-B | 6.1 |
| | | | 819 | | | |
| Ex. 35 | 80MFA | DPGPE | Lucirin | POCAII/ | Mold-B | 4.4 |
| | | | TPO | Neopelex | | |
| | | | | No. 25 | | |
| Ex. 36 | 80MFA | DPGPE | Irgacure | PB821 | Mold-B | 5.7 |
| | | | 819 | | | |
| Ex. 38 | 80MFA | DPGPE | Lucirin | DOPA-33 | Mold-B | 5.7 |
| | | | TPO | | | |

### RIB PRECURSOR COMPOSITIONS FOR EXAMPLES 34, 36 and 38

### Example 34

50 pbw of Epoxyester 80MFA, 50 pbw of DPGPE and 0.7 pbw of Irgacure 819 were mixed. 100.7 pbw of the solution, 7.0 pbw of DOPA-17 and 571.5 pbw of glass frit (RFW-030) were mixed with Conditioning Mixer AR-250. The viscosity of the rib precursor was 10.0 Pa-s.

### Example 36

50 pbw of Epoxyester 80MFA, 50 pbw of DPGPE, 4.4 pbw of a stabilizer commercially available from Ajinomoto-Fine-Techno Co., Inc. under the trade designation “Ajisper PB821” and 0.7 pbw of Irgacure 819 were mixed. The solution and 474.41 pbw of glass frit (RFW-030) were mixed with Conditioning Mixer AR-250. The viscosity of the rib precursor was 23.0 Pa-s.

### Example 38

50 pbw of Epoxyester 80MFA, 50 pbw of DPGPE, 7.0 pbw of DOPA 33 and 1.4 pbw of Lucirin TPO were mixed. The solution and 572.3 pbw of glass frit (RFW-030) were mixed with Conditioning Mixer AR-250. The viscosity of the paste was 10.0 Pa-s.

### EXAMPLE 39

### Reuseability of Microstructured Mold Was Evaluated

A rectangular, 400 mm wide×700 mm long, having the following lattice concave pattern was prepared with the same composition of Mold B. Vertical grooves; 1,845 lines, 300 micron pitch, 210 micron height, 110 micron of groove bottom width (rib top width), 200 micron of groove top width (rib bottom width) Lateral grooves; 608 lines, 510 micron pitch, 210 micron height, 40 micron of groove bottom width (rib top width), 200 micron of groove top width (rib bottom width)

A 400 mm×700 mm×2.8 mm glass plate was prepared to use as substrate. The glass plate was primed (coated A-174, γ-methacryloxypropyl trimethoxysilane manufactured by Nippon Unicar Company LTD).

The cured microstructured rib precursor on the glass substrate obtained above was sintered at 550° C. for 1 hour. The organic components of the cured precursor exhibited complete burn out and no defects of the microstructures after the sintering were observed with a microscope.

The reuseablity of the mold was evaluated with the rib precursor composition of Example 24 in the same manner as previously described except the exposure time was 60 seconds. This procedure was repeated with the same microstructured mold. The mold was suitable for use even after 30 times reuses.

1. A method of making a display panel component comprising:
providing a mold having a polymeric microstructured surface suitable for making barrier ribs;
placing a rib precursor composition comprising a curable organic binder and an inorganic material between the microstructured surface of the mold and a substrate;
curing the precursor material; and
removing the mold wherein the method is repeated with the same polymeric mold at least 2 times.

2. The method of claim 1 wherein the polymeric mold is transparent and has a haze of less than 10% after a single use.

3. The method of claim 2 wherein the polymeric mold has a haze of less than 10% after being reused at least 5 times.

4. The method of claim 1 wherein the mold is flexible.

5. The method of claim 1 wherein the microstructured surface of the mold comprises a cured polymeric material.

6. The method of claim 5 wherein the polymeric material is the reaction product of at least one (meth)acrylate oligomer and at least one (meth)acrylate monomer.

7. The method of claim 5 wherein the microstructured surface is disposed on a polymeric support film.

8. The method of claim 8 wherein the rib precursor composition comprises photoinitiator and the composition is photocured through the patterned substrate, though the mold, or a combination thereof.

9. The method of claim 1 wherein the curable organic binder has a solubility parameter and the rib precursor further comprises an organic diluent having a solubility parameter less than the solubility parameter of the curable organic binder.

10. The method of claim 9 wherein the solubility parameter of the diluent is less than the curable organic binder by a difference of greater than 2 [MJ/m³]^{1/2}.

11. The method of claim 9 wherein the solubility parameter of the diluent is less than the curable organic binder by a difference of at least 5 [MJ/m³]^{1/2}.

12. The method of claim 9 wherein the solubility parameter of the diluent is less than the curable organic binder by a difference of greater than 8 [MJ/m³]^{1/2}.

13. The method of claim 1 further comprising sintering the cured rib precursor at a temperature wherein the organic binder is volatilized.

14. A curable composition comprising:
at least one inorganic particulate material;
at least one curable organic binder having a solubility parameter;
at least one diluent having a solubility parameter less than the solubility parameter of the curable organic binder; and
optionally photoinitiator, stabilizer, and mixtures thereof.

15. The stabilizer in claim 14 is selected from a basic acrylic polymer, a phosphate ester, and mixtures thereof.

16. The curable paste of claim 14 wherein the curable organic binder comprises at least two (meth)acrylate groups.

17. The curable paste of claim 16 wherein the curable organic binder is an (meth)acrylated epoxy, (meth)acrylate urethane, (meth)acrylated polyether, (meth)acrylated polyester, (meth)acrylated polyolefin, (meth)acrylated (meth)acrylic, and mixtures thereof

18. The curable paste of claim 16 wherein the curable organic binder is selected from bisphenol A diglycidyl ether (meth)acrylate, ethylene glycol diglycidyl ether (meth)acrylate, glycerin diglycidyl ether (meth)acrylate, and mixtures thereof.

19. The curable paste of claim 14 wherein the diluent has a boiling point of less than 350° C.

20. The curable paste of claim 14 wherein the diluent is selected from alkylene glycol monoalkyl ether, dialkylene glycol monoalkyl ether, polyalkylene glycol monoalkyl ether, alkylene glycol monoalkyl ether acetate, dialkyl succinate, dialkyl adipate, dialkyl glutarate, and mixtures thereof

21. The curable paste of claim 14 wherein
a) the curable organic binder comprises bisphenol A diglycidyl ether (meth)acrylate and the diluent is selected from diethylene glycol monoethyl ether, 2-hexyloxyethanol, dipropylene glycol monopropyl ether, dipropylene glycol monobutyl ether, and mixtures thereof;
b) the curable organic binder comprises ethylene glycol diglycidyl ether (meth)acrylate and the diluent is selected from diethylene glycol monoethyl ether, dipropylene glycol monopropyl ether, dipropylene glycol monobutyl ether, diethylene glycol monoethyl ether acetate, and mixtures thereof; or
c) the curable organic binder comprises glycerin diglycidyl ether (meth)acrylate and the diluent is selected from butane diol, 2-hexyloxyethanol, diethyl succinate, dipropylene glycol monopropyl ether, dipropylene glycol monobutyl ether, diethylene glycol monoethyl ether acetate, and mixtures thereof.

22. A display component comprising:
a substrate and a plurality of barrier ribs comprised of a cured composition disposed on the transparent substrate wherein the cured composition comprises the reaction product of claim 14.

23. A method of making a microstructured component:
providing a polymeric mold having a microstructured surface suitable;
placing a curable material comprising a curable organic binder and an inorganic material between the microstructured surface of the mold and a substrate;
curing the curable material; and
removing the mold wherein the method is repeated with the same polymeric mold at least 2 times.
